(19) United States
(12) Patent Application Publication
(10) Pub. No.: US 2008/0306640 A1
(43) Pub. Date: Dec. 11, 2008

(54) SYSTEM AND METHOD FOR WIRELESSLY INTERFACING A LOCOMOTIVE CONSIST

(76) Inventors: Wil C. Rosenthal, Wattsburg, PA (US); Brian D. Lawry, Erie, PA (US); Adejare Ojekale, Calgary (CA); Brian Celidonia, Erie, PA (US); John D. Walker, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/758,817

(22) Filed: Jun. 6, 2007

(51) Int. Cl. G06F 19/00

(52) U.S. Cl. 701/19

(57) ABSTRACT

A system is provided to wirelessly interface a locomotive consist including a plurality of locomotives. One locomotive of the plurality of locomotives includes a plurality of trainline cables to transmit a respective plurality of trainline signals during operation of the locomotive. The plurality of trainline cables extend between a trainline connector positioned adjacent to each end of the locomotive. The system includes at least one first connector device to wirelessly transmit the plurality of trainline signals of at least one first locomotive to at least one second connector device of at least one second locomotive. Each first connector device is coupled to at least one trainline connector of at least one first locomotive, and each second connector device is coupled to at least one trainline connector of at least one second locomotive.

### FIELD OF THE INVENTION

The present invention relates to a locomotive consist, and more particularly, to a system and method for wirelessly interfacing a locomotive consist.

### BACKGROUND OF THE INVENTION

Locomotive consists typically include more than one locomotive in various arrangements used to haul freight, such as train cars, over a predetermined trip. The collective power of the locomotive in the locomotive consist is used to haul the freight, and each arrangement of the locomotive consist additionally affects the ability to haul the freight. One such arrangement involves positioning all locomotives of the locomotive consist at the front of the train, and positioning all train cars behind the locomotives. Another such arrangement commonly known as a distributed power arrangement, involves positioning one portion of the locomotives of the locomotive consist at the front of the train, and a second portion of the locomotives of the locomotive consist at the rear of the train, with train cars positioned between the first and second portions of locomotives. The distributed power arrangement may be used for particular applications, such as when the train is longer than a particular length, for example.

During operation of the locomotive consist, the locomotives should operate in unison with a lead locomotive at the front of the locomotive consist in terms of its operating characteristics. The locomotive includes a plurality of trainline cables passing from a trainline connector positioned at one end of the locomotive to another trainline connector positioned at the opposite end of the locomotive. The plurality of trainline cables transmits a respective plurality of trainline signals used for operating a number of locomotive systems during operation of the locomotive.

In a typical locomotive consist, the trainline cables for the locomotive are passed from a lead locomotive at the front of the train to a subsequent trail locomotive, and in turn are passed from the trail locomotive to a subsequent trail locomotive further down the locomotive consist. By passing the trainline cables between the locomotives in the locomotive consist, the trainline signals of the lead locomotive are shared with the locomotive in the locomotive consist, thereby allowing the locomotives of the locomotive consist to be operated in unison with the lead locomotive and with one another.

However, passing trainline cables between the locomotives in a locomotive consist provides several drawbacks, including restricting the particular arrangements of the locomotives in the locomotive consist, and requiring trainline cable detachment upon separating adjacent locomotives. Additionally, trainline cables are costly and are cumbersome to pass between locomotives. Accordingly, it would be advantageous to provide a system for communicating trainline signals in between the locomotives of a locomotive consist without the necessity of passing trainline cables in between the locomotives. Additionally, it would be advantageous to provide such a system for an existing locomotive consist that passes trainline cables between the locomotives.

### BRIEF DESCRIPTION OF THE INVENTION

In one embodiment of the present invention, a system is provided for wirelessly interfacing a locomotive consist including a plurality of locomotives. One locomotive of the plurality of locomotives includes a plurality of trainline cables to transmit a respective plurality of trainline signals during operation of the locomotive. The plurality of trainline cables extend between a trainline connector positioned adjacent to each end of the locomotive. The system includes at least one connector device coupled to at least one trainline connector of the locomotive. More particularly, the at least one connector device includes at least one first connector device coupled to a trainline connector of at least one first locomotive of the plurality of locomotives. Each first connector device wirelessly transmits the plurality of trainline signals of the at least one first locomotive to at least one second connector device coupled to a trainline connector of at least one second locomotive of the plurality of locomotives.

In one embodiment of the present invention, a method is provided for wirelessly interfacing a locomotive consist including a plurality of locomotives. One locomotive of the plurality of locomotives includes a plurality of trainline cables to transmit a respective plurality of trainline signals during operation of the locomotive. The plurality of trainline cables extends between a trainline connector positioned adjacent each end of the locomotive. The method includes coupling at least one first connector device to a trainline connector of at least one first locomotive of the plurality of locomotives. Additionally, the method includes coupling at least one second connector device to a trainline connector of at least one second locomotive of the plurality of locomotives.

In one embodiment of the present invention, computer readable medium containing program instructions are provided for wirelessly interfacing a locomotive consist including a plurality of locomotives. One locomotive of the plurality of locomotives includes a plurality of trainline cables to transmit a respective plurality of trainline signals during operation of the locomotive. The plurality of trainline cables extends between a trainline connector positioned adjacent each end of the locomotive. The computer readable medium includes a computer program code for wirelessly transmitting the plurality of trainline signals of the at least one first locomotive to at least one second connector device for operating the at least one first locomotive and at least one second locomotive in unison.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a schematic side view of an embodiment of a system for wirelessly interfacing a locomotive consist according to the present invention.

FIG. 2 is a schematic side view of an embodiment of a system for wirelessly interfacing a locomotive consist shown in FIG. 1

FIG. 3 is a schematic side view of an embodiment of a system for wirelessly interfacing a locomotive consist according to the present invention.

FIG. 4 is a schematic side view of an embodiment of a system for wirelessly interfacing a locomotive consist according to the present invention.

FIG. 5 is a schematic side view of an embodiment of a system for wirelessly interfacing a locomotive consist according to the present invention.

FIG. 6 is a schematic side view of an embodiment of a system for wirelessly interfacing a locomotive consist according to the present invention.

FIG. 7 is a schematic side view of an embodiment of a system for wirelessly interfacing a locomotive consist according to the present invention.

FIG. 8 is a schematic side view of an embodiment of a system for wirelessly interfacing a locomotive consist according to the present invention.

FIG. 9 is a schematic exploded view of a connector device for a lead locomotive of a locomotive consist according to the present invention.

FIG. 10 is a schematic exploded view of a connector device for a trail locomotive of a locomotive consist according to the present invention.

FIG. 11 is a flow chart illustrating an exemplary embodiment of a method for wirelessly interfacing a locomotive consist.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

FIG. 1 illustrates a system 10 for wirelessly interfacing a locomotive consist 12 including a plurality of locomotives 14,16 and an attached train car 50 positioned along a track 9. One of skill in the art will readily recognize that FIG. 1 and the additional FIGS of each embodiment of the present invention address the communication of the trainline signals over the locomotive consist, and thus do not include inherent features such as wheels/axles and physical interconnections of the locomotives, for example. Although FIG. 1 illustrates two locomotives 14,16 in the locomotive consist, the locomotive consist may include any number of locomotives. In the illustrated exemplary embodiment of FIG. 1, the lead locomotive 14 is positioned at the front of the locomotive consist 12, and is followed by a trail locomotive 16. The locomotives 14,16 respectively include a plurality of trainline cables 18,20 to transmit a respective plurality of trainline signals 22,24 during operation of the locomotives. The plurality of trainline cables 18,20 illustratively extend between respective trainline connectors (26,28) (30,32) positioned adjacent to each respective end (34,36) (38,40) of the respective lead locomotive 14 and the trail locomotive 16.

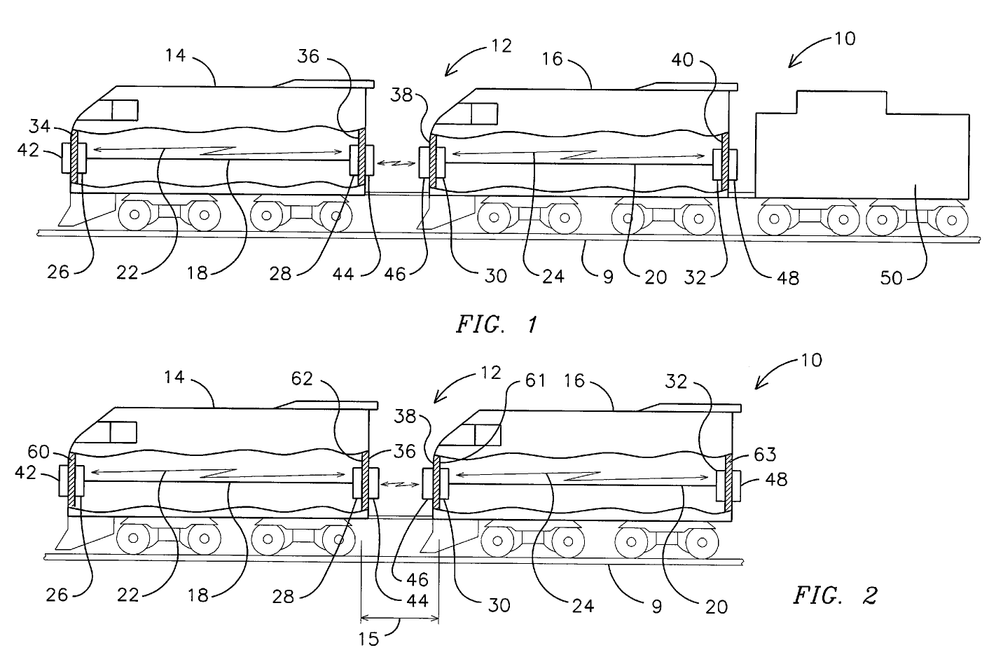

As illustrated in the embodiment of FIGS. 1-2, the system 10 for wirelessly interfacing the locomotive consist 12 illustratively includes a connector device (42,44) (46,48) coupled to each respective trainline connector (26,28) (30,32) through respective end plates (60,62) (61,63) of the respective lead locomotive 14 and trail locomotive 16. The connector devices (42,44)(46,48) are a first connector device 42,44 coupled to respective trainline connectors 26,28 of the lead locomotive 14 to wirelessly transmit the plurality of trainline signals 22 of the lead locomotive to a respective second connector device 46,48 coupled to respective trainline connectors 30,32 of the trail locomotive 16. The wireless transmission of the plurality of trainline signals 22 of the lead locomotive 14 from the respective trainline connectors 26,28 of the lead locomotive 14 to the respective trainline connectors 30,32 of the trail locomotive 16 is to facilitate operation of the lead locomotive 14 and trail locomotive 16 in unison. Although FIGS. 1-2 illustrate one connector device coupled to each trainline connector, more than one connector device may be coupled to each trainline connector. Additionally, although the embodiment of FIGS. 1-2 illustrate two connector devices coupled to the locomotive, only one connector may be coupled to one connector device of the locomotive, such as the lead locomotive, for example.

Upon transmitting the plurality of trainline signals 22, which can include signals related to the operation of one or more locomotive systems, such as brake systems, for example, both the lead locomotive 14 and trail locomotive 16 operate in unison by sharing the same signals related to the operation of their respective locomotive systems. Similarly, for each embodiment of the present invention, wirelessly transmitting each plurality of trainline signals between locomotives facilitates operating the respective locomotives in unison. Although FIG. 1 illustrates two adjacent locomotives, and a lead locomotive wirelessly transmitting a plurality of trainline signals to a trail locomotive, two nonadjacent locomotives may wirelessly transmit a plurality of trainline signals, and a trail locomotive may transmit a plurality of trainline signals to a subsequent adjacent or nonadjacent trail locomotive, as discussed in the additional exemplary embodiments below.

As illustrated in the exemplary embodiment of FIGS. 1 and 2, where the lead locomotive 14 and trail locomotive 16 are adjacent, the first connector device 44 and second connector device 46 that engage in wireless transmission of the plurality of trainline signals 22 of the lead locomotive are positioned at respective adjacent ends 36,38 of the lead locomotive and trail locomotive. Additionally, in the exemplary embodiment of FIG. 2, the wireless transmission of the plurality of trainline signals 22 from the lead locomotive 14 to the adjacent trail locomotive 16 includes a limited range wireless transmission based upon the separation 15 of the trainline connector 28 of the lead locomotive 14 and the trainline connector 30 of the trail locomotive 16. In an exemplary embodiment of the present invention, a limited range of the wireless transmission is less than four feet, and more specifically between two and four feet, for example.

In the exemplary embodiment of FIG. 2, the wireless transmission between each lead locomotive 14 and trail locomotive 16 is uniquely encoded with a unique identifier specific to the wireless transmission between the lead locomotive 14 and the trail locomotive 16.

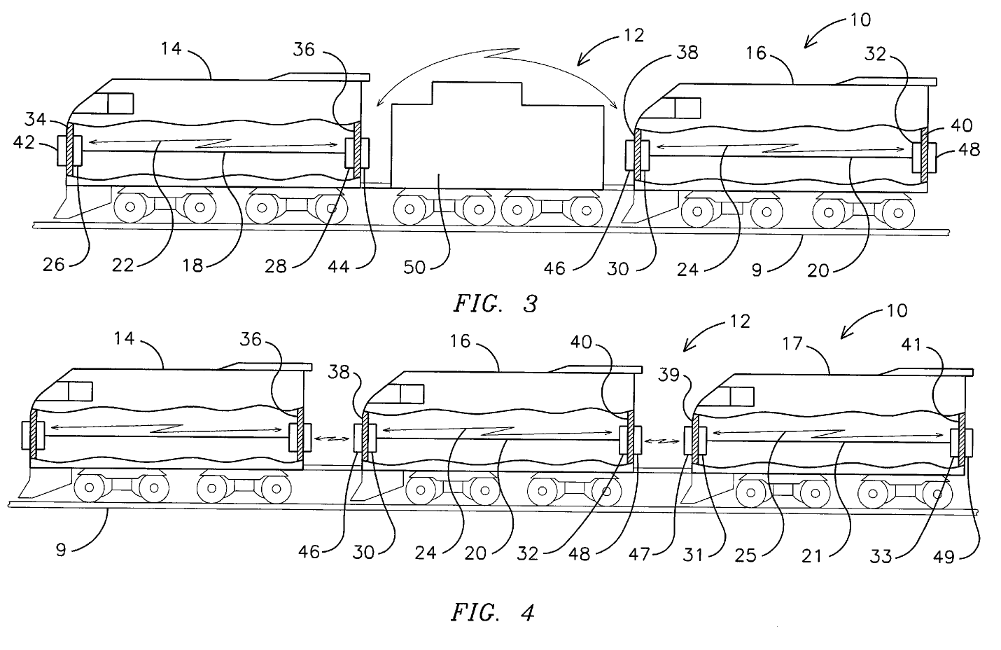

FIG. 3 illustrates an exemplary embodiment of the system 10 for wirelessly interfacing a locomotive consist 12 including a plurality of locomotives 14,16 positioned along a track 9. In the exemplary embodiment of FIG. 3, unlike the embodiment of FIG. 1, the lead locomotive 14 and trail locomotive 16 are non-adjacent such that the train car 50 separates the lead locomotive 14 and trail locomotive 16 in a distributed power arrangement, as appreciated by one of skill in the art. Although FIG. 3 illustrates one train car 50, more than one train car may separate the lead locomotive 14 and trail locomotive 16. The wireless transmission between the lead locomotive 14 and the trail locomotive 16 may occur between any one of the trainline connectors 26,28 and respective connector devices 42,44 of the lead locomotive 14, and any one of the trainline connectors 30,32 and respective connector device 46,48 of the trail locomotive 16. Additionally, the wireless transmission of the plurality of trainline signals 22 is uniquely encoded with a unique identifier specific to the wireless transmission between the lead locomotive 14 and the trail locomotive 16. Although FIG. 3 illustrates a lead locomotive 14 and trail locomotive 16 positioned in a nonadjacent arrangement, two trail locomotives may be similarly positioned in a nonadjacent arrangement and wirelessly communicate a plurality of trainline signals, as described in an exemplary embodiment below.

FIG. 4 illustrates an exemplary embodiment of the system 10 for wirelessly interfacing a locomotive consist 12 including the lead locomotive 14 with the trail locomotive 16, and another trail locomotive 17. In the exemplary embodiment of FIG. 4, unlike the embodiments of FIGS. 1 and 3, the trail locomotive 16 wirelessly transmits a plurality of trainline signals 24 from the trainline cables 20 of the trail locomotive 16 to the trainline cables 21 of the second trail locomotive 17. The trainline cables 21 of the second trail locomotive 17 extend between trainline connectors 31,33 positioned adjacent to each respective end 39,41 of the second trail locomotive 17. Although FIG. 4 illustrates a wireless transmission of a plurality of trainline signals between two adjacent trail locomotives, the wireless transmission may occur between two nonadjacent trail locomotives, as discussed in the embodiment below. The connector devices (46,48)(47,49) of the respective first trail locomotive 16 and second trail locomotive 17 are a first connector device 46,48 coupled to respective trainline connectors 30,32 of the first trail locomotive 16 to wirelessly transmit the plurality of trainline signals 24 of the first trail locomotive to a respective second connector device 47,49 coupled to respective trainline connectors 31,33 of the second trail locomotive 17. The wireless transmission of the plurality of trainline signals 24 of the first trail locomotive 16 from the respective trainline connectors 30,32 to the respective trainline connectors 31,33 of the second trail locomotive 17 is to facilitate operation of the first and second trail locomotives in unison by equating the trainline signals 24 of the trail locomotive 16 with the trainline signals 25 of the second trail locomotive 17.

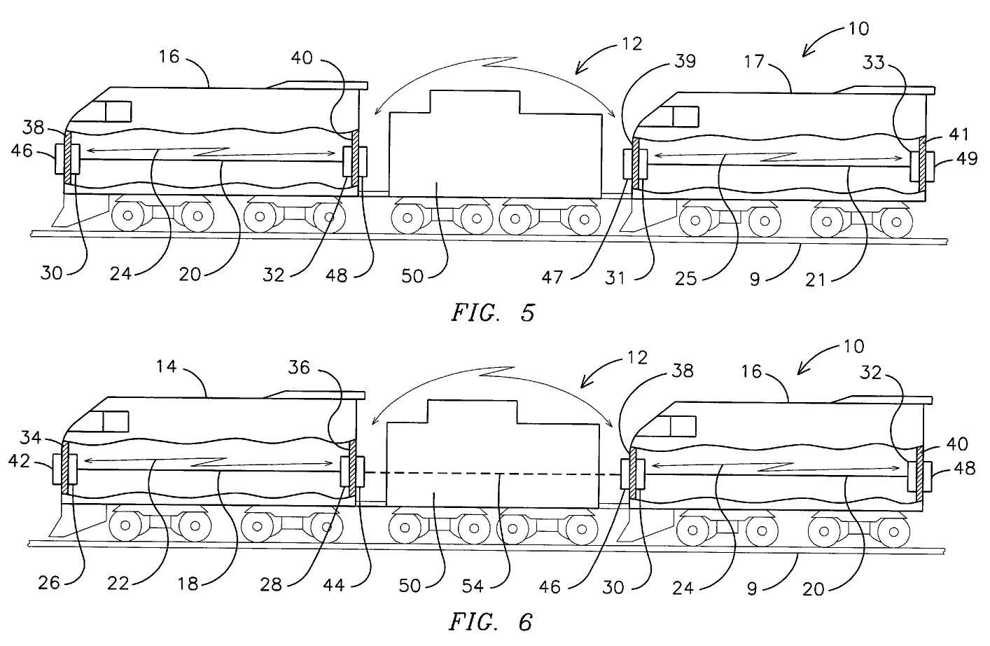

FIG. 5 illustrates an exemplary embodiment of the system 10 for wirelessly interfacing a locomotive consist 12 including a plurality of locomotives 16,17 positioned along a track, including a plurality of trail locomotives 16,17. In the exemplary embodiment of FIG. 5, unlike the embodiments of FIGS. 1, 3, and 4, the trail locomotive 16 wirelessly transmits the plurality of trainline signals 24 to a nonadjacent second trail locomotive 17. The connector device (46,48)(47,49) of the respective first trail locomotive 16 and second trail locomotive 17 are a first connector device 46,48 coupled to respective trainline connectors 30,32 of the trail locomotive 16 to wirelessly transmit the plurality of trainline signals 24 of the trail locomotive 16 to a respective second connector device 47,49 coupled to respective trainline connectors 31,33 of the second trail locomotive 17. The wireless transmission of the plurality of trainline signals 24 of the first trail locomotive 16 from the respective trainline connectors 30,32 to the respective trainline connectors 31,33 of the second trail locomotive 17 is to facilitate operation of the first and second trail locomotives in unison by equating the trainline signals 24 of the trail locomotive 16 with the trainline signals 25 of the second trail locomotive 17.

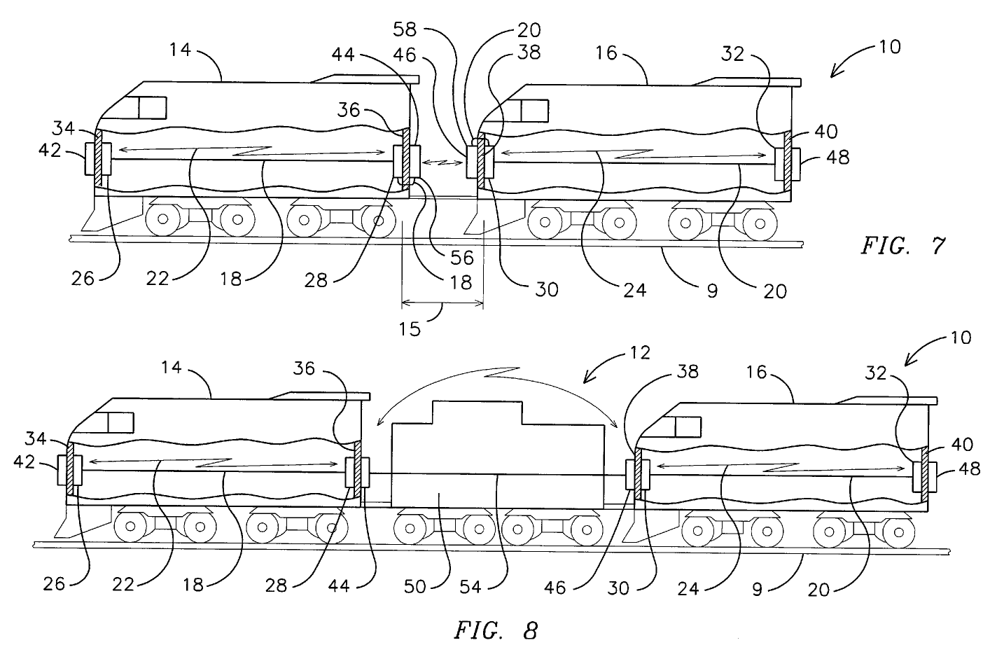

The exemplary embodiment of the system 10 illustrated in FIG. 3 includes the wireless transmission of the plurality of trainline signals 22 of the lead locomotive 14 from one of the trainline connectors 26,28 to one of the trainline connectors 30,32 of the trail locomotive 16 to replace a portion 54 of trainline cables (FIG. 6) previously extending between the lead locomotive and trail locomotive that previously passed the plurality of trainline signals 22 of the lead locomotive 14 to the trail locomotive 16. As illustrated in the exemplary embodiment of FIG. 7, upon replacing the portion 54 of the trainline cables extending between the lead locomotive 14 and trail locomotive 16, the trainline cables 18,20 extend out from the lead locomotive 14 and trail locomotive 16 and are pluggable into respective redundant receptacles 56,58 in a respective first connector device 44 and second connector device 46.

Although exemplary embodiments of the present invention discuss removing or replacing the portion 54 of the trainline cables between the locomotives, in the exemplary embodiment of the system 10 illustrated in FIG. 8, the portion 54 of the trainline cables extending between the locomotives 14,16 is respectively coupled to the first controller device 44 and the second controller device 46 of the respective lead locomotive 14 and trail locomotive 16 to provide a backup connection to the wireless transmission of the plurality of trainline signals 22 between the lead and trail locomotives. Similarly, the plurality of trainline cables between the locomotives may be coupled to each controller throughout the locomotive consist to provide a backup connection for each wireless transmission within the locomotive consist.

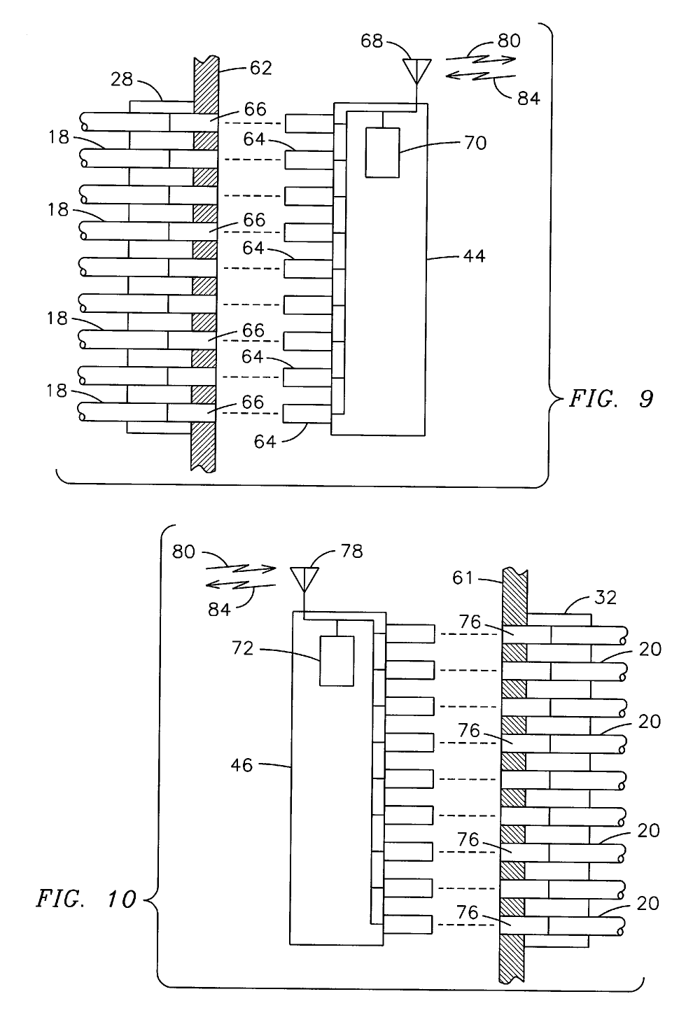

As illustrated in the exemplary embodiments of FIGS. 1 and 2, each first connector device 42,44 and second connector device 46,48 are coupled to their respective trainline connectors (26,28) (30,32) through respective end plates 60,62 of the lead locomotive 14 and end plates 61,63 of the trail locomotive 16. FIG. 9 illustrates an exemplary embodiment of a first connector 44 of the present invention, particularly in regard to its coupling to the trainline connector 28 through the end plate 62 of the lead locomotive 14. However, each first connector device 42, and each second connector device 46,48,47,49 include similar structure to the first connector device 44 and are similarly coupled to their respective trainline connector through the respective end plate of their respective locomotive, and thus require no further discussion herein.

As illustrated in the exemplary embodiment of FIG. 9, the first connector device 44 includes a plurality of connectors 64 connected to a respective plurality of receptacles 66 through the end plate 62 and trainline connector 28, which are respectively coupled to the plurality of trainline cables 18. By connecting to the trainline connector 28, the first connector device 44 connects to the plurality of trainline cables 18. The first connector device 44 further illustratively includes a transceiver 68 coupled to the plurality of connectors 64 to wirelessly transmit the plurality of trainline signals 22 of the lead locomotive 14 to the trail locomotive 16. The first connector device further illustratively includes a first processor 70 coupled to the plurality of connectors 64 and the transceiver 68 to communicate with a second processor 72 of the second connector device 46 to uniquely identify the wireless transmission between the lead locomotive 14 and the trail locomotive 16 and to facilitate the wireless transmission between the lead locomotive and trail locomotive.

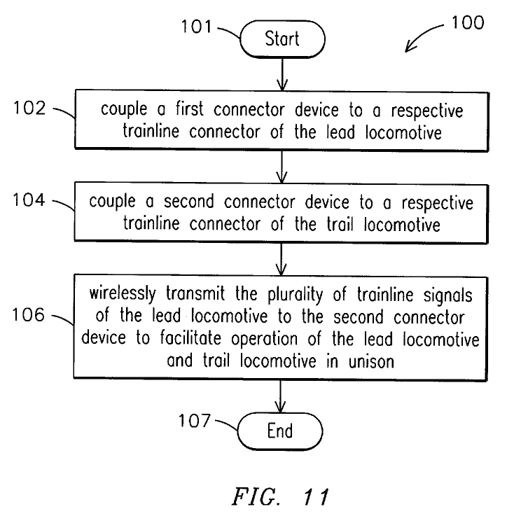

As illustrated in the exemplary embodiment of FIG. 10, the second connector device 46 is coupled to the trainline connector 32 at an end plate 61 of one end 38 of the trail locomotive 16. In the exemplary embodiment, the second connector device 46 illustratively includes a plurality of connectors 74 connected to a respective plurality of receptacles 76 of the trainline connector 32 to respectively connect to the plurality of trainline cables 20. By connecting to the trainline connector 32, the second connector device 46 connects to the plurality of trainline cables 20. As further illustrated in the exemplary embodiment of FIG. 10, the second connector device 46 includes a transceiver 78 coupled to the plurality of connectors 74 to wirelessly receive the plurality of trainline signals 22 of the lead locomotive 14. Additionally, the second connector device 46 illustratively includes a second processor 72 coupled to the plurality of connectors 74 and the transceiver 78 to communicate with the first processor 70 of the first connector device 44 to recognize a unique identifier for the wireless transmission and facilitate the wireless transmission between the lead locomotive and trail locomotive. Although FIGS. 9 and 10 illustrate a plurality of male connectors on the connector devices, and a plurality of female receptacles within the trainline connectors, each having a square cross section, the plurality of connectors and receptacles may be interchangeably male or female and may take any cross-sectional shape, as appreciated by one of skill in the art.

In the exemplary embodiments of FIGS. 9-10, the transceiver 78 of the second connector device 46 may additionally wirelessly transmit the trainline signals 24 of trail locomotive 16 to the first connector device 44. Additionally, the transceiver 68 of the first connector device 44 may additionally wirelessly receive the plurality of trainline signals 24 of the trail locomotive 16 from the second connector device 46.

In the exemplary embodiments of FIGS. 9-10, the first processor 70 and the second processor 72 engage in a request and acknowledge sequence including the first processor 70 initiating the request and acknowledge sequence between the first and second connector device 44,46 by causing the transceiver 68 of the first connector device 44 to wirelessly transmit a communication request signal 80 including a unique identifier component for the wireless transmission to the transceiver 78 of the second connector device 46. The second processor 72 receives the communication request signal 80, recognizes the unique identifier component for the wireless transmission between the lead locomotive 14 and trail locomotive 16 and causes the transceiver 78 to wirelessly transmit a communication acknowledge signal 84 including the unique identifier component to the transceiver 68 of the first connector device 44. Upon receiving the communication acknowledge signal 84, the first processor 70 causes the transceiver 68 of the first connector device 44 to wirelessly transmit the plurality of trainline signals 22 including the unique identifier component to the transceiver 78 of the second connector box 46. The request and acknowledge sequence further includes the second processor 72 receiving the plurality of trainline signals 22 from the lead locomotive 14 and communicating the plurality of trainline signals of the lead locomotive to the trainline cables 20 of the trail locomotive through the trainline connector 32 and plurality of receptacles 76. The trainline cables 20 of the trail locomotive 16 may subsequently pass the plurality of trainline signals 22 of the lead locomotive 14 from one end 38 to an opposite end 40 of the trail locomotive 16 for wirelessly transmitting the plurality of train signals 22 of the lead locomotive from the trail locomotive to a subsequent trail locomotive, for example.

In the exemplary embodiment discussed above, the unique identifier component may be a generated random number by the first processor 70, such as a generated random number that is at least 8 digits long, and for which the likelihood of duplication by an external locomotive consist is extremely remote. In an additional exemplary embodiment of the present invention, the unique identifier component may be a generated random number by the first processor that is at least 9 digits long, to further reduce the likelihood of duplication by an external locomotive. The first and second connector devices 44,46 may communicate using one of a DCIP, ATM and Bluetooth® protocol. One of skill in the art will readily recognize that several different protocols and security processes may be utilized to uniquely identify the transmission between the locomotives for providing a secure transmission, such as a security tracker for remotely logging onto a secure server, a passkey fob, dipswitches, magnetic readers, and the embodiments of the present invention are not limited to those protocols and unique identification security processes expressly listed herein but include those within the skill and knowledge of one of skill in the art.

In an exemplary embodiment of the present invention, the lead locomotive 14 wirelessly transmits its trainline signals 22 to a trail locomotive 16, as discussed in the above exemplary embodiment of FIGS. 9-10, which in turn wirelessly transmits the trainline signals 22 of the lead locomotive to a subsequent trail locomotive, using the same steps discussed above in the exemplary embodiment of FIGS. 9-10, which in turn wirelessly transmits the trainline signals 22 of the lead locomotive to a subsequent trail locomotive. This process continues until every locomotive in the locomotive consist 12 includes the trainline signals 22 of the lead locomotive 14 and thus all locomotives in the locomotive consist operate in unison. Additionally, the system 10 may be utilized such that every locomotive in the locomotive consist 12 shares the trainline signals 24 of a trail locomotive, as oppose to the lead locomotive.

FIG. 11 illustrates an embodiment for a method 100 for wirelessly interfacing the locomotive consist 12 including the plurality of locomotives 14,16 and the attached train car 50 positioned along the track 9. The locomotives 14,16 respectively include the plurality of trainline cables 18,20 to transmit a respective plurality of trainline signals 22,24 during operation of the locomotives. The plurality of trainline cables 18,20 illustratively extends between trainline connectors (26,28) (30,32) positioned adjacent to each respective end (34,36) (38,40) of the respective lead locomotive 14 and trail locomotive 16. The method begins (block 101) by coupling (block 102) the first connector device 42,44 to the respective trainline connector 26,28 of the lead locomotive 14 of the plurality of locomotives. The method subsequently involves coupling (block 104) the second connector device 46,48 to the respective trainline connector 30,32 of the trail locomotive 16 of the plurality of locomotive 14,16. The method additionally includes wirelessly transmitting (block 106) the plurality of trainline signals 22 of the lead locomotive 14 to the second connector device 46,48 to facilitate operation of the lead locomotive and trail locomotive in unison, before the method ends at block 107.

Based on the foregoing specification, the above-discussed embodiments of the invention may be implemented using computer programming or engineering techniques including computer software, firmware, hardware or any combination or subset thereof, wherein the technical effect is to wirelessly interface a locomotive consist. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for wirelessly interfacing a locomotive consist comprising a plurality of locomotives, one of said plurality of locomotives comprising a plurality of trainline cables for transmitting a respective plurality of trainline signals during operation of said locomotive, said plurality of trainline cables extending between each end of said locomotive, said plurality of trainline cables coupled to a respective trainline connector adjacent each end of said locomotive, said system comprising:
at least one first connector device configured to wirelessly transmit said plurality of trainline signals of at least one first locomotive;
at least one second connector device of at least one second locomotive; and
wherein said at least one first connector device being coupled to at least one trainline connector of said at least one first locomotive, said at least one second connector device being coupled to at least one trainline connector of said at least one second locomotive.

2. The system for wirelessly interfacing a locomotive consist according to claim 1, wherein said wireless transmission of said plurality of trainline signals of said at least one first locomotive from said trainline connector of said at least one first locomotive to said trainline connector of said at least one second locomotive is configured to operate said at least one first locomotive and said at least one second locomotive in unison.

3. The system for wirelessly interfacing a locomotive consist according to claim 1, wherein said at least one first and said at least one second locomotive are adjacent, and wherein said first and second connector devices are positioned at respective adjacent ends of said first and second locomotive.

4. The system for wirelessly interfacing a locomotive consist according to claim 3, wherein said wireless transmission of said plurality of trainline signals of said at least one first locomotive to said at least one adjacent second locomotive comprises a limited range wireless transmission based upon the separation of said trainline connector of said at least one first locomotive and said trainline connector of said at least one adjacent second locomotive.

5. The system for wirelessly interfacing a locomotive consist according to claim 4, wherein said limited range is less than four feet.

6. The system for wirelessly interfacing a locomotive consist according to claim 4, wherein said wireless transmission between said at least one first locomotive and said at least one second locomotive is uniquely encoded with a unique identifier for said wireless transmission between said at least one first locomotive and said at least one second locomotive.

7. The system for wirelessly interfacing a locomotive consist according to claim 1, wherein said at least one first and said at least one second locomotive are non-adjacent such that at least one train car separates said at least one first and said at least one second locomotive in a distributed power arrangement.

8. The system for wirelessly interfacing a locomotive consist according to claim 7, wherein said wireless transmission between said at least one first and said at least one second locomotive is uniquely encoded with a unique identifier for said wireless transmission between said at least one first and said at least one second locomotive.

9. The system for wirelessly interfacing a locomotive consist according to claim 7, wherein said wireless transmission of said plurality of trainline signals of said at least one first locomotive from said trainline connector of said at least one first locomotive to said trainline connector of said at least one second locomotive is for replacing said trainline cables extending between said at least one first locomotive and said at least one second locomotive for passing said plurality of trainline signals of said at least one first locomotive from said trainline connector of said at least one first locomotive to said trainline connector of said at least one second locomotive.

10. The system for wirelessly interfacing a locomotive consist according to claim 9, wherein upon said replacement of said trainline cables extending between said at least one first locomotive and said at least one second locomotive for passing said plurality of trainline signals, said trainline cables extending between said at least one first locomotive and said at least one second locomotive are pluggable into a redundant receptacle in a respective first connector device and second connector device.

11. The system for wirelessly interfacing a locomotive consist according to claim 9, wherein upon said replacement of said trainline cables extending between said at least one first locomotive and said at least one second locomotive for passing said plurality of trainline signals, said trainline cables extending between said at least one first locomotive and said at least one second locomotive are respectively coupled to said at least one first controller device and said at least one second controller device as a backup connection to said wireless transmission for communicating said plurality of trainline signals between said at least one first locomotive and said at least one second locomotive.

12. The system for wirelessly interfacing a locomotive consist according to claim 1, wherein said at least one first connector device is coupled to said trainline connector at an end plate of each end of said at least one first locomotive, and wherein said at least one first connector device comprises:
a plurality of connectors connected to a respective plurality of receptacles of said trainline connector respectively coupled to said plurality of trainline cables, for respectively connecting said plurality of connectors to said plurality of trainline cables;
a transceiver coupled to said plurality of connectors for wirelessly transmitting said plurality of trainline signals of said first locomotive to said second locomotive;
a first processor coupled to said plurality of connectors and said transceiver for communicating with a second processor of said second connector device for uniquely identifying said wireless transmission between said first locomotive and said second locomotive and facilitating said wireless transmission between said first locomotive and second locomotive.

13. The system for wirelessly interfacing a locomotive consist according to claim 12, wherein each second connector device is coupled to said trainline connector at an end plate of each end of said at least one second locomotive, and wherein said at least one second connector device comprises:
a plurality of connectors connected to a respective plurality of receptacles of said trainline connector for respectively connecting to said plurality of trainline cables, for respectively connecting said plurality of connectors to said plurality of trainline cables;
a transceiver coupled to said plurality of connectors for wirelessly receiving said plurality of trainline signals of said first locomotive;
a second processor coupled to said plurality of connectors and said transceiver for communicating with said first processor of said first connector device for recognizing a unique identifier for said wireless transmission and facilitating said wireless transmission between said first locomotive and second locomotive.

14. The system for wirelessly interfacing a locomotive consist according to claim 13, wherein said transceiver of said second connector device is further for wirelessly transmitting said trainline signals of second locomotive to said first connector device, and wherein said transceiver of said first connector device is further for wirelessly receiving said plurality of trainline signals of said second locomotive from said second connector device.

15. The system for wirelessly interfacing a locomotive consist according to claim 13, wherein said first processor and said second processor engage in a request and acknowledge sequence comprising:
said first processor initiating said request and acknowledge sequence between said first and second connector device comprising causing said transceiver of said first connector device to wirelessly transmit a communication request signal including a unique identifier component for said wireless transmission to said transceiver of said second connector device;
said second processor receiving said communication request signal, recognizing said unique identifier component for said wireless transmission between said first and second connector device, and causing said transceiver of said second connector device to wirelessly transmit a communication acknowledge signal including said unique identifier component to said transceiver of said first connector device; and
upon receiving said communication acknowledge signal, said first processor causing said transceiver of said first connector device to wirelessly transmit said plurality of trainline signals including said unique identifier component to said transceiver of said second connector box.

16. The system for wirelessly interfacing a locomotive consist according to claim 15, wherein said request and acknowledge sequence further comprises:
said second processor receiving said plurality of trainline signals from said first locomotive and communicating said plurality of trainline signals of said first locomotive to said trainline cables of said second locomotive through said trainline connector and plurality of receptacles; and
said trainline cables of said second locomotive for passing said plurality of trainline signals of said first locomotive from one end to an opposite end of said second locomotive for wirelessly transmitting said plurality of train signals of said first locomotive from said second locomotive.

17. The system for wirelessly interfacing a locomotive consist according to claim 15, wherein said unique identifier component comprises a generated random number by said first processor.

18. The system for wirelessly interfacing a locomotive consist according to claim 17, wherein said generated random number is at least 8 digits long.

19. The system for wirelessly interfacing a locomotive consist according to claim 15, wherein said first and second connector device communicate using one of a DCIP, ATM and Bluetooth® protocol.

20. The system for wirelessly interfacing a locomotive consist according to claim 1, wherein said locomotive consist comprises a plurality of locomotives including a lead locomotive and at least one trailing locomotive.

21. The system for wirelessly interfacing a locomotive consist according to claim 20, wherein said at least one first locomotive comprises said lead locomotive, and wherein said at least one second locomotive comprises said at least one trailing locomotive.

22. The system for wirelessly interfacing a locomotive consist according to claim 21, wherein said lead locomotive and said at least one trailing locomotive are one of adjacent and nonadjacent.

23. The system for wirelessly interfacing a locomotive consist according to claim 20, wherein at least one first locomotive comprises a first of said at least one trailing locomotive, and wherein said at least one second locomotive comprises a second of said at least one trailing locomotive.

24. The system for wirelessly interfacing a locomotive consist according to claim 23, wherein said first and second trailing locomotives are one of adjacent and nonadjacent.

25. A method for wirelessly interfacing a locomotive consist comprising a plurality of locomotives, one of said plurality of locomotives comprising a plurality of trainline cables for transmitting a respective plurality of trainline signals during operation of said locomotive, said plurality of trainline cables extending between each end of said locomotive, said plurality of trainline cables coupled to a respective trainline connector adjacent each end of said locomotive, said method comprising:
coupling at least one first connector device to a trainline connector of at least one first locomotive of said plurality of locomotives; and
coupling at least one second connector device to a trainline connector of at least one second locomotive of said plurality of locomotives.

26. The method for wirelessly interfacing a locomotive consist according to claim 25, further comprising wirelessly transmitting said plurality of trainline signals of at least one first locomotive to at least one second connector device for operating said at least one first locomotive and said at least one second locomotive in unison.

27. The method for wirelessly interfacing a locomotive consist according to claim 26, wherein said at least one first and said at least one second locomotive are adjacent, and wherein said first and second connector devices are positioned at respective adjacent ends of said first and second locomotive.

28. The method for wirelessly interfacing a locomotive consist according to claim 27, wherein said wirelessly transmitting of said plurality of trainline signals of said at least one first locomotive to each adjacent second locomotive comprises wirelessly transmitting said plurality of trainline signals at a limited range based upon the separation of said trainline connector of said at least one first locomotive and said trainline connector of each adjacent second locomotive.

29. The method for wirelessly interfacing a locomotive consist according to claim 27, further comprising uniquely encoding said wireless transmission between said at least one first locomotive and said at least one second locomotive with a unique identifier for said wireless transmission between said at least one first locomotive and said at least one second locomotive.

30. The method for wirelessly interfacing a locomotive consist according to claim 26,
wherein said at least one first and second locomotive are non-adjacent such that at least one train car separates said at least one first and second locomotive in a distributed power arrangement;
and wherein said method further comprises replacing said trainline cables extending between said at least one first locomotive and said at least one second locomotive for passing said plurality of trainline signals of said at least one first locomotive from said trainline connector of said at least one first locomotive to said trainline connector of said at least one second locomotive with said wireless transmission of said plurality of trainline signals of said at least one first locomotive from said trainline connector of said at least one first locomotive to said trainline connector of said at least one second locomotive.

31. The method for wirelessly interfacing a locomotive consist according to claim 29, wherein upon said replacing said trainline cables extending between said at least one first locomotive and said at least one second locomotive, said method further includes plugging said trainline cables extending between said at least one first locomotive and said at least one second locomotive into a redundant receptacle in a respective first connector device and second connector device.

32. The method for wirelessly interfacing a locomotive consist according to claim 30, wherein upon said replacing said trainline cables extending between said at least one first locomotive and said at least one second locomotive, said method further includes respectively coupling said trainline cables extending between said at least one first locomotive and said at least one second locomotive to said at least one first controller device and said at least one second controller device to provide a backup connection to said wireless transmission for communicating said plurality of trainline signals between said at least one first locomotive and said at least one second locomotive.

33. The method for wirelessly interfacing a locomotive consist according to claim 26, wherein said at least one first connector device comprises:
a plurality of connectors connected to a respective plurality of receptacles of said trainline connector respectively coupled to said plurality of trainline cables, for respectively connecting said plurality of connectors to said plurality of trainline cables;
a transceiver coupled to said plurality of connectors for wirelessly transmitting said plurality of trainline signals of said first locomotive to said second locomotive;
a first processor coupled to said plurality of connectors and said transceiver for communicating with a second processor of said second connector device for uniquely identifying said wireless transmission between said first locomotive and said second locomotive and facilitating said wireless transmission between said first locomotive and second locomotive.

34. The method for wirelessly interfacing a locomotive consist according to claim 33, wherein said at least one second connector device comprises:
a plurality of connectors connected to a respective plurality of receptacles of said trainline connector for respectively connecting to said plurality of trainline cables, for respectively connecting said plurality of connectors to said plurality of trainline cables;
a transceiver coupled to said plurality of connectors for wirelessly receiving said plurality of trainline signals of said first locomotive;
a second processor coupled to said plurality of connectors and said transceiver for communicating with said first processor of said first connector device for recognizing a unique identifier for said wireless transmission and facilitating said wireless transmission between said first locomotive and second locomotive.

35. The method for wirelessly interfacing a locomotive consist according to claim 34, wherein said first processor and said second processor engage in a request and acknowledge sequence comprising:
said first processor initiating said request and acknowledge sequence between said first and second connector device comprising causing said transceiver of said first connector device to wirelessly transmit a communication request signal including a unique identifier component for said wireless transmission to said transceiver of said second connector device;
said second processor receiving said communication request signal, recognizing said unique identifier component for said wireless transmission between said first and second connector device, and causing said transceiver of said second connector device to wirelessly transmit a communication acknowledge signal including said unique identifier component to said transceiver of said first connector device;
upon receiving said communication acknowledge signal, said first processor causes said transceiver of said first connector device to wirelessly transmit said plurality of trainline signals including said unique identifier component to said transceiver of said second connector box; and
said second processor receiving said plurality of trainline signals from said first locomotive and communicating said plurality of trainline signals of said first locomotive to said trainline cables of said second locomotive through said trainline connector and plurality of receptacles.

36. Computer readable medium containing program instructions for wirelessly interfacing a locomotive consist comprising a plurality of locomotives, one locomotive of said plurality of locomotives comprising a plurality of trainline cables for transmitting a respective plurality of trainline signals during operation of the locomotives, said plurality of trainline cables extending between each end of the locomotive, said plurality of trainline cables coupled to a respective trainline connector adjacent each end of the locomotive, the computer readable medium comprising:
a computer program code for wirelessly transmitting said plurality of trainline signals of at least one first locomotive from at least one first connector device coupled to a trainline connector of said at least one first locomotive to at least one second connector device for operating said at least one first locomotive and said at least one second locomotive in unison.
